(19) United States
(12) Patent Application Publication
(10) Pub. No.: US 2007/0214619 A1
(43) Pub. Date: Sep. 20, 2007

(54) Cadaver mouth closure device

(76) Inventor: Davis L. Sons, Winchester, TN (US)

Correspondence Address: KRAMER & AMADO, P.C., 1725 DUKE STREET, SUITE 240, ALEXANDRIA, VA, 22314, US

(21) Appl. No.: 11/376,113

(22) Filed: Mar. 16, 2006

(51) Int. Cl. A01N 1/00

(52) U.S. Cl. 27/25.1

(57) ABSTRACT

A cadaver mouth closure device includes a first member section terminating at a distal end in a first anchor for penetrating an upper or lower jaw of a cadaver. The device further includes a second member section terminating at a distal end in a second anchor for penetrating the other jaw of the cadaver. The first and second member sections are releasably engaged to secure closure of the cadaver mouth. The first member section terminates at a proximal end in a buckle section having a tubular recess and a pawl section. The second member section terminates at a proximal end in a toothed section defining a plurality of teeth. Upon insertion of the toothed section into the tubular recess, the pawl section engages at least one of the plurality of teeth to thereby secure closure of the cadaver mouth. Each of the anchors rotates after insertion into the respective jaw portion of the cadaver to enhance insertion of the toothed section into the tubular recess. The pawl section releasably engages with the tooth to permit readjustment of the closure device.

### FIELD OF THE INVENTION

The present invention generally relates to a closure device. More particularly, the present invention relates to a mouth closure device to be implanted in the jaw of a cadaver to retain the jaw in a closed position.

### BACKGROUND OF THE INVENTION

As of the year 2000, Americans spend billions of dollars arranging more than two million funerals for family members and friends. Funerals rank among the most expensive purchases many consumers will ever make. A traditional funeral, including a casket and vault, represents a cost to the consumer of approximately $6,000. Additional costs may also be incurred as related to ceremonial items such as flowers, obituary notices, acknowledgment cards, or limousines. Many funerals run well over $10,000. A traditional, full-service funeral usually includes a viewing or visitation of the deceased, a hearse to transport the body to the funeral site, and burial, entombment or cremation of the remains. A traditional funeral generally includes embalming and dressing the body for viewing in a service.

Many funeral homes require embalming as a prerequisite to viewing the deceased in a service. Embalming generally includes a series of steps to prepare the body for viewing. The body is first placed on stainless steel or porcelain table, and then washed with a germicide-insecticide-olfactant. The insides of the nose and mouth are next swabbed with the germicide solution. Rigor mortis (stiffness) can be relieved by massage. In rare cases, tendons and muscles are cut in order to place the body in a more natural state of repose—especially if limbs are distorted by disease such as arthritis. Massage cream is worked into the face and hands to keep the skin soft and pliable. Facial features are set by putting cotton in the nose and eye caps below the eyelids. Arterial embalming is begun by injecting embalming fluid into an artery while the blood is drained from a nearby vein or from the heart. The embalming fluid is usually a mixture of formaldehyde or other chemical and water. After arterial embalming, body cavities such as the stomach and bladder are embalmed. A trocar is used to withdraw gas and fluids from the body cavities before embalming fluid is injected into the torso. Incisions and holes in the body are then sewn closed or filled with trocar buttons. Finally, the nails are manicured, any missing facial features are molded from wax, head hair is styled, and makeup is used on the face and hands. The body is then dressed and placed in the casket.

As part of the embalming process, particular attention is given to the face. The mouth is traditionally tied shut with wire or sutures. A molded mouth former may optionally be placed in the mouth before or after tying of the mouth. The mouth former has a textured side that grips the lips. Stay cream is optionally used on the mouth to avoid dehydration and help hold the lips in place. Mastic compound may be optionally inserted into the mouth to provide a natural shape. Tying of the mouth is cumbersome and requires that the lips meet in a natural position. If the lips are too tight, the facial expression will appear to scowl, if too loose, the facial expression appears unnatural. When using a suture, a curved needle is traditionally used to thread suture string through the jaw below the gums. Suture string is also threaded through the upper jaw into to the right nostril, threaded through the septum of the nose into the left nostril, and then passed back down into the mouth. The two ends of suture are then tied. Alternatively, wire is attached about the upper and lower jaw behind the lips for later attachment by wire or suture string. Once the cadaver jaw is closed, repositioning and/or rearrangement of the facial features about the mouth becomes difficult.

Accordingly, there remains a need for an apparatus and method to quickly and easily secure the cadaver jaw in a position of natural repose. There also remains a need for an apparatus and method to quickly and easily reposition a cadaver jaw during the embalming process.

### SUMMARY OF THE INVENTION

In one preferred form, the present invention provides an apparatus to maintain the mouth of a cadaver in a closed position. To give a desirable appearance, the jaw is retained in a set position that may be adjusted or changed. In particular, a technician, such as an embalmer, may position and retain the jaw in small increments until a desired position is reached.

In another preferred form, the present invention provides a ratcheting connection between two flexible members each respectively attached to the upper or lower portion of the jaw. At the far end of each flexible member is an anchor that is implanted into the jaw. One of the flexible members has a set of ratcheting teeth that extends from the anchor to the opposite end of the member. The other flexible member has a ratcheting connector attached to the opposite end of the anchor. The ratcheting connector has at least one pawl member that is designed to releasably engage the ratcheting teeth. After both of the flexible members are implanted into the jaw the ratcheting teeth are brought into connection with the ratcheting connector so that the embalmer can secure the closure of the cadaver's mouth. The device can be slowly tightened until a desired position between the upper and lower jaw members is reached. If the embalmer finds that he has closed the mouth too tightly or is required to reopen the jaw to perform an additional embalming procedure, he may disengage the pawl member from the ratcheting teeth and slidably disengage the two flexible members. In this way the position of the mouth may be adjusted until a proper closure is obtained. Thus, the present invention allows an embalmer to position the jaw of a cadaver with greater ease and precision than provided by previous devices.

In yet another preferred form, the present invention provides a cadaver mouth closure device including a first member section terminating at a distal end in a first anchor for penetrating an upper or lower jaw of a cadaver. The device further includes a second member section terminating at a distal end in a second anchor for penetrating the other jaw of the cadaver. The first and second member sections are releasably engaged to secure closure of the cadaver mouth. The first member section terminates at a proximal end in a buckle section having a tubular recess and a pawl member. The second member section terminates at a proximal end in a toothed section defining a plurality of teeth. Upon insertion of the toothed section into the tubular recess, the pawl member engages at least one of the plurality of teeth to thereby secure closure of the cadaver mouth. Each anchor is rotatable after insertion into the respective jaw portion of the cadaver to enhance insertion of the toothed section into the tubular recess. The pawl member is releasable from the tooth to thereby permit access within the cadaver mouth or readjustment of the closure device.

Further areas of applicability of the present invention will become apparent from the detailed description provided hereinafter. It should be understood that the detailed description and specific examples, while indicating the preferred embodiments and best mode of the invention, are intended for purposes of illustration only and are not intended to limit the scope of the invention. Further, the following description and accompanying drawings provide multiple features and embodiments that are usable together, but may be shown separately to avoid prolixity and facilitate ease of understanding.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a front view of a mouth closure device securing a cadaver jaw in a closed position;

FIG. 2 is a side view of the mouth closure device and cadaver jaw shown in FIG. 1;

FIG. 3 is an elevated side view of a mouth closure device according to an embodiment of the present invention;

FIG. 4 is a sectional view of an anchor;

FIG. 4A is a section view of an anchor according to an alternate embodiment;

FIG. 5 is an elevated perspective view of a first anchor member;

FIG. 6 is a side view of the first anchor member of FIG. 5;

FIG. 7 is a top view of the first anchor member of FIG. 5;

FIG. 8 is a front view of the first anchor member of FIG. 5;

FIG. 9 is an elevated perspective view of a second anchor member;

FIG. 10 is a side view of the second anchor member of FIG. 9;

FIG. 11 is a top view of the second anchor member of FIG. 9;

FIG. 12 is a front view of the second anchor member of FIG. 9;

FIG. 13 is an elevated perspective view of a buckle closure mechanism according to another embodiment of the invention; and

FIG. 14 is a side view of the buckle closure mechanism of FIG. 13.

### DETAILED DESCRIPTION OF THE PREFERRED EMBODIMENTS

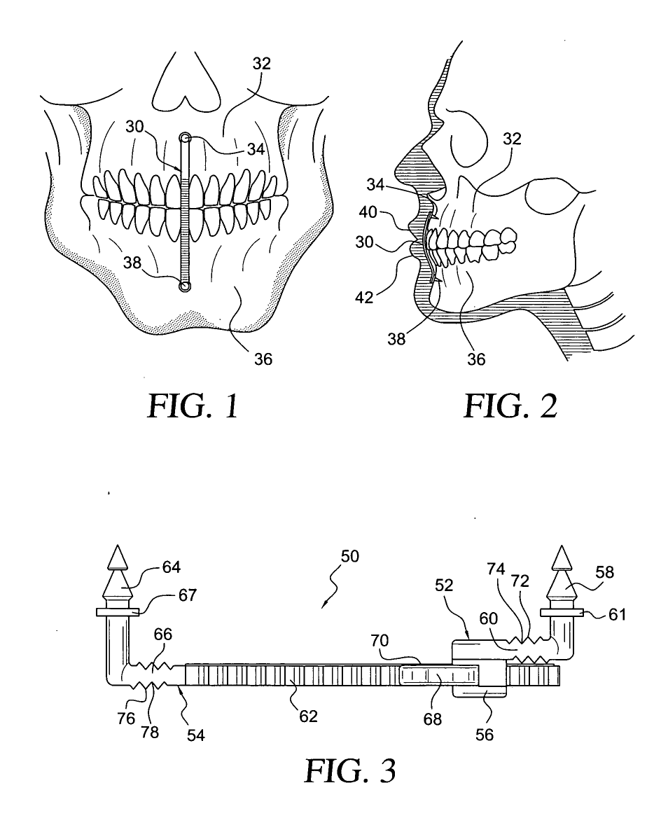

Turning now to the drawings, and in particular FIG. 1, mouth closure device 30 is illustrated maintaining a cadaver jaw in a closed position. In FIG. 1 the skin has been removed for clarity. Closure device 30 is attached to upper jaw 32, known as the superior maxillary bone, by way of a first anchor 34. Likewise, closure device 30 is attached to lower jaw 36, known as the inferior maxillary bone, by way of a second anchor 38. The anchors 34 and 38 may also embed in the inner tissue and gums that form part of the upper and lower jaw of the cadaver.

FIG. 2 is a side view of the mouth closure device 30 illustrating placement with respect to the tissue forming part of the upper and lower jaw. The first anchor 34 of closure device 30 is disposed beneath upper lip 40 of the cadaver. In particular, first anchor 34 is set within the bone and tissue of the upper jaw 32. Likewise, second anchor 38 of closure device 30 is disposed beneath lower lip 42 of the cadaver.

FIG. 3 is an elevated side view of a mouth closure device 50 according to an embodiment of the present invention. Closure device 50 includes a first anchor member 52 that is attached to second anchor member 54. First anchor member 52 includes a first closure section 56 that is attached to first anchor 58 by way of first extension section 60. Preferably, first closure section 56 is a buckle section. Second anchor member 54 includes a second closure section 62 that is connected to second anchor 64 by way of second extension section 66. Preferably, second closure section 62 is a toothed section that is releasably engageable with buckle section 56. In order to effect closure of the cadaver jaw, as set forth in greater detail below, first anchor 58 is implanted into the bone and tissue of the upper cadaver jaw and second anchor 64 is implanted into the bone and tissue of the lower cadaver jaw.

According to the illustrated embodiment of FIG. 3, first anchor 58 and second anchor 64 may pivot after respective insertion into the cadaver in order to align toothed section 62 with buckle section 56. After alignment, toothed section 62 is inserted into buckle section 56 and is caught on alternate sides thereof by a pair of alternately disposed pawl sections 68. Each of the pawl sections 68 is preferably integrally formed with buckle section 56 and flexibly deforms as toothed section 62 is inserted into buckle section 56. As illustrated, pawl section 68 engages a particular tooth 70 to thereby lock mouth closure device 50 into position. A second pawl section (not shown) likewise engages a second tooth on the opposite side of buckle section 56.

As illustrated, the first extension section 60 of first anchor member 52 includes a plurality of optional ribs 72 that are interconnected by a plurality of optional grooves 74. According to an optional embodiment, the combination of ribs and grooves are oppositely disposed on the top and bottom of first extension section 60. This embodiment permits first anchor 58 to flex with respect to buckle section 56 to enhance conformity to the underlying features of the cadaver jaw. According to another embodiment, the combination of ribs and grooves are disposed about the entire periphery of first extension section 60 to enhance flexion in all axial directions. According to yet another embodiment of the present invention, first extension section 60 does not include ribs or grooves, and flexion is provided by the nature of the flexible plastic material.

Likewise, the second extension section 66 of second anchor member 54 includes a plurality of optional ribs 76 that are interconnected by a plurality of optional grooves 78 to form a corrugated section. According to an optional embodiment, the combination of ribs and grooves are oppositely disposed on the top and bottom of second extension section 66. This embodiment permits second anchor 64 to flex with respect to toothed section 62 to enhance conformity to the underlying features of the cadaver jaw. According to another embodiment, the combination of ribs and grooves are disposed about the entire periphery of second extension section 66 to enhance flexion in all axial directions. According to yet another embodiment of the present invention, second extension section 66 does not include ribs or grooves, and flexion is provided by the nature of the flexible plastic material.

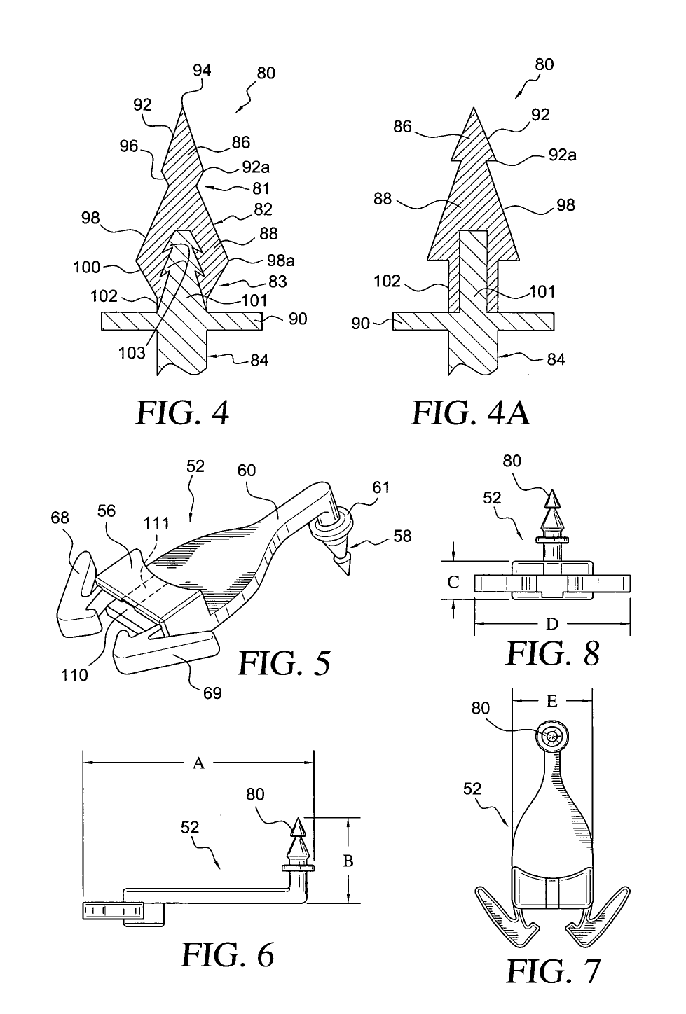

FIG. 4 is a sectional view of anchor 80 according to an embodiment of the present invention. Anchor 80 is preferably formed from a metallic anchor cap section 82 that is attached to anchor base section 84. Preferably, anchor base section 84 is integrally molded as part of an anchor member. Thus, when anchor 80 is a part of first anchor member 52, anchor base section 84 is integrally molded with first extension section 60 and buckle section 56. Likewise, when anchor 80 is a part of second anchor member 54, anchor base section is preferably integrally molded with second extension section 60 and toothed section 62.

The geometry of anchor 80 permits insertion, retention, and pivotal rotation within the cadaver jaw. As illustrated, anchor 80 is formed from a first pivotal retaining section 86, a second pivotal retaining section 88, and a retaining flange 90. First pivotal retaining section 86 is formed from a first conical surface 92 that terminates in an apex 94 for penetrating the cadaver jaw and tissue. First conical surface 92 mates with reverse frusto-conical surface 96, which is indented from the base 92a of first conical surface 92. The cadaver jaw and tissue are resilient such that upon insertion of conical surface 92, the remaining bone and tissue form around the base 92a of first conical surface 92 and mates with reverse frusto-conical surface 96. Accordingly, the first pivotal retaining section pivotally secures anchor 80 to the jaw.

The geometry of anchor 80 further includes second pivotal retaining section 88 connected between first pivotal retaining section 86 and retaining flange 90. Second pivotal retaining section 88 is a conical section formed from frusto-conical surface 98 and reverse frusto-conical surface 100. The reverse frusto-conical surface 100 connects to shaft portion 102, which in turn connects to retaining flange 90. The cadaver jaw and tissue are resiliently pliable such that upon insertion of frusto-conical surface 98 and reverse frusto-conical surface 100, the remaining bone and tissue form around the base 98a and shaft portion 102. Retaining flange 90 prevents over-insertion of anchor 80 into the cadaver jaw. Through use of the disclosed anchor 80, the resilient bone and tissue of the cadaver engage anchor 80 at least about two surfaces, namely reverse frusto-conical surface 96 and reverse frusto-conical surface 100. Accordingly, the second pivotal retaining section 88 pivotally secures anchor 80 to the jaw.

A portion of the distal end of frusto-conical surface 98 has a smaller circumference than base 92a of first conical surface 92. Accordingly, the portion of the distal end of frusto-conical surface 98 and the reverse frusto-conical surface 96 define a first groove section 81 that is adjacent to the base 92a. Likewise, reverse frusto-conical surface 100 and shaft portion 102 have a smaller circumference than base 98a of frusto-conical surface 98. Accordingly, reverse frusto-conical surface 100 and shaft portion 102 define a second groove section 83 that is adjacent to the base 98a.

According to a preferred embodiment, anchor cap section 82 is formed from metal that is attached to anchor base section 84. Formation of anchor cap section 82 with metal provides a hard surface for insertion into the cadaver jaw. According to an alternate embodiment, anchor cap section 82 is integrally formed with anchor base section 84 as part of a continuous mold. In this embodiment, anchor cap section is formed with a rigid plastic that is hard enough to penetrate the bone and tissue of the cadaver jaw.

According to a preferred embodiment, anchor base section 84 is formed from plastic that is inserted into interior recess 101 of anchor cap section 92. As illustrated, anchor cap section 92 defines a plurality of interior annular indentions 103 within interior recess 101. The illustrated indentions 103 terminate in a pointed recess. According to an embodiment, interior indentions 103 are threaded and anchor base section 84 is screwed therein. According to another embodiment, anchor base section 84 is heated to become pliable before insertion into interior recess 101. According to yet another embodiment, interior recess 101 is cylindrical with at least one annular rib defined therein for engaging anchor base section 84. Alternatively, interior recess 101 is cylindrical and anchor base section 84 is joined thereto through the use of an adhesive such as solvent, glue, or sonic bonding.

FIG. 4A is a sectional view of anchor 80 according to an alternate embodiment. The geometry of anchor 80 permits insertion and retention within the cadaver jaw. As illustrated, anchor 80 is formed from first pivotal retaining section 86, second pivotal retaining section 88, and retaining section 90. First pivotal retaining section 86 is formed from a first conical surface 92 that terminates in base 92a. Second pivotal retaining section 88 connects first pivotal retaining section 86 to retaining section 90 and is formed from frusto-conical surface 98. The frusto-conical surface 98 terminates in base 98a. Retaining section 90 prevents over-insertion of anchor 80 into the cadaver jaw. Through use of the disclosed anchor 80, the resilient bone and tissue of the cadaver-engage anchor 80 at least about two surfaces, namely reverse frusto-conical surface 96 and reverse frusto-conical surface 100.

FIG. 5 is an elevated perspective view of a first anchor member 52 according to an embodiment of the present invention. FIG. 5 is the same as FIG. 3 with the exception that first extension section 60 does not have ribs and grooves. Preferably, first anchor member 52 includes buckle section 56 that is continuously formed with first extension section 60. Buckle section 56 includes a tubular recess 110 that is configured and arranged to receive toothed section 62 from second anchor member 54. Tubular recess 110 includes a longitudinal slot 111 for receiving a corresponding elongated projection in second anchor member 54. As toothed section 62 is moved through tubular recess 110, the distal end thereof slides along first extension section 60. After toothed section 62 enters tubular recess 110, first pawl section 68 and second pawl section 69 engage the side teeth therein. First pawl section 68 and second pawl section 69 are preferably integrally molded with buckle section 56 and are connected by way of a living hinge. Each of the pawls resiliently deform into the closed position. However, when pressure is applied to the distal end of each pawl, the pawl will flexibly deform and thereby disengage with the toothed section 62. Each pawl may be manually disengaged or disengaged with a tool, such as a small pair of pliers.

FIGS. 6-8 are respective side, bottom, and front views of first anchor member 52 of FIG. 5 showing dimensions according to an embodiment of the invention. Dimensions are an aspect of the present invention because the mouth closure device must be small enough to be disposed beneath the lips of a cadaver without providing a visual indication. Further, the present invention must be strong enough to adequately retain the cadaver jaw in the closed position while also being large enough to be manually manipulated by a mortician during installation thereof. According to an embodiment of the present invention, the dimensions of first anchor member 52 are provided by Table I.

TABLE I

| Reference Letter | Dimension in inches |
|---|---|
| A | .75 to 1.15 |
| B | .26 to .66 |
| C | .04 to .30 |
| D | .42 to .82 |
| E | .13 to .53 |

According to a more preferably embodiment of the present invention, the dimensions of first anchor member 52 are provided by Table II.

TABLE II

| Reference Letter | Dimension in inches |
|---|---|
| A | .85 to 1.05 |
| B | .36 to .56 |
| C | .08 to .26 |
| D | .52 to .72 |
| E | .23 to .43 |

According to a preferred embodiment of the present invention, the dimensions of first anchor member 52 are provided by Table III.

TABLE III

| Reference Letter | Dimension in inches |
|---|---|
| A | .95 |
| B | .46 |
| C | .16 |
| D | .62 |
| E | .33 |

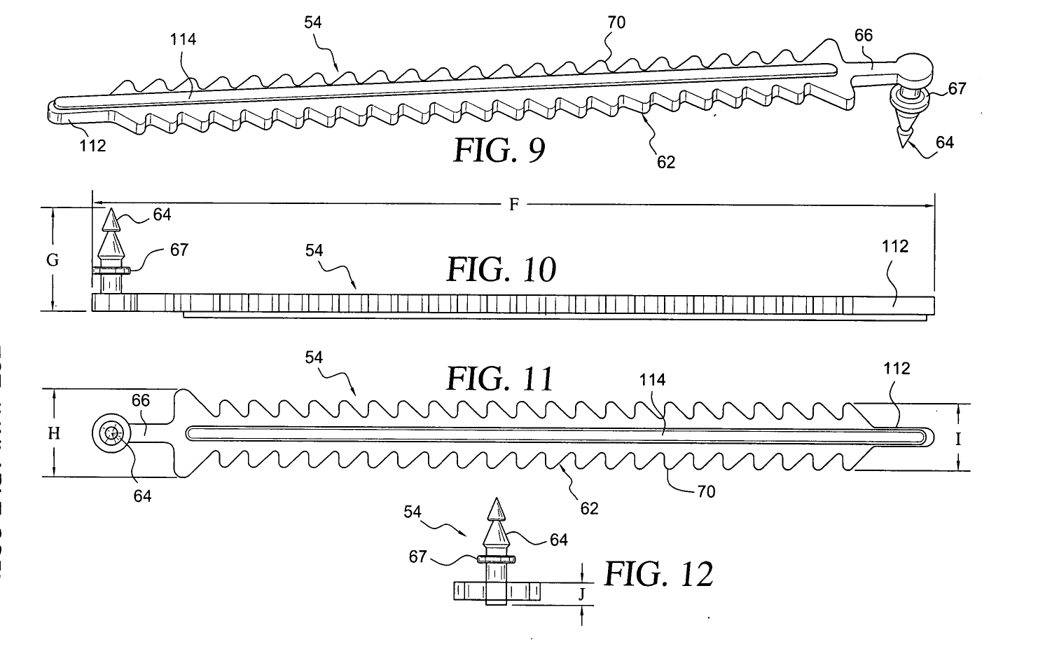

FIG. 9 is an elevated perspective view of second anchor member 54 according to an embodiment of the present invention. FIG. 9 is the same as FIG. 3 with the exception that second extension section 66 does not have ribs and grooves. Toothed section 62 includes a plurality of teeth 70 that are preferably symmetrically disposed about the sides of section 62. Toothed section 62 terminates at a distal end in second extension section 66 and at a proximal end in threading section 112. The top surface of second anchor member 54 includes an elongated rib 114 that is preferably integrally formed therewith. Elongated rib 114 is configured and arranged to be received within longitudinal slot 111 of tubular recess 110 in first anchor member 52. When elongated rib 114 mates with longitudinal slot 111, the first anchor member 52 is generally maintained in alignment with second anchor member 54. After threading section 112 is inserted into tubular recess 110 of first anchor member 52, teeth 70 engage first and second pawl sections 68 and 69 to thereby retain the anchor members in a fixed relation.

FIGS. 10-12 are respective side, bottom and front views of the second anchor member 54 of FIG. 9 showing dimensions according to an embodiment of the invention. Dimensions are an aspect of the present invention because the mouth closure device must be small enough to be disposed beneath the lips of a cadaver without providing a visual indication. Further, the present invention must be strong enough to adequately retain the cadaver jaw in the closed position while also being large enough to be manually manipulated by a mortician during installation thereof. According to an embodiment of the present invention, the dimensions of second anchor member 54 are provided by Table IV.

TABLE IV

| Reference Letter | Dimension in inches |
|---|---|
| F | 1.5 to 5 |
| G | .18 to .58 |
| H | .12 to .32 |
| I | .08 to .40 |
| J | .03 to .12 |

According to a more preferably embodiment of the present invention, the dimensions of first anchor member 52 are provided by Table V.

TABLE V

| Reference Letter | Dimension in inches |
|---|---|
| F | 2.11 to 4.11 |
| G | .28 to .48 |
| H | .22 to .42 |
| I | .14 to .34 |
| J | .05 to .09 |

According to a preferred embodiment of the present invention, the dimensions of first anchor member 52 are provided by Table VI.

TABLE VI

| Reference Letter | Dimension in inches |
|---|---|
| F | 3.11 |
| G | .38 |
| H | .32 |
| I | .24 |
| J | .07 |

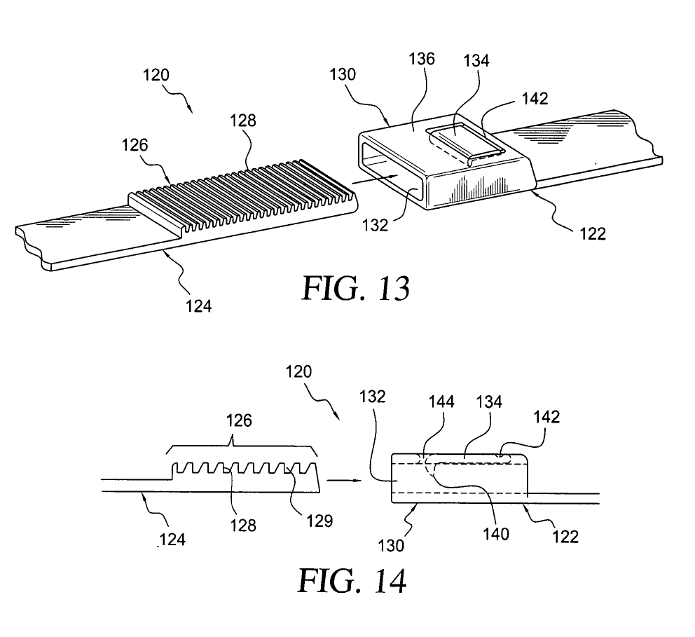

FIGS. 13-14 are respective elevated perspective and sides views of a buckle closure mechanism 120 according to another embodiment of the invention. Buckle closure mechanism 120 includes first member section 122 that may be releasably joined to second member section 124. According to a preferred embodiment, each of the member sections 122 and 124 are respectively attached to anchors, as set forth above with respect to FIG. 4. According to the embodiment of FIG. 13, toothed section 126 is formed from a plurality of teeth 128, which define a plurality of corresponding grooves 129. Preferably, toothed section 126 is disposed on a single side of second member section 124. According to an alternate embodiment, a pair of toothed sections is disposed with each section on alternate sides of second member section 124. A pair of corresponding pawl sections is then disposed with each pawl section on opposite sides of buckle section 130 for releasable engagement therewith.

First member section 122 terminates in buckle section 130. The buckle section 130 further defines a tubular recess 132. The tubular recess 132 is configured and arranged to receive toothed section 126 of second member section 124. Pawl section 134 is flexibly attached to side portion 136 of buckle section 130 about groove 138. According to a preferred embodiment, pawl section 134 is integrally formed with buckle section 130 and flexes about living hinge 142. The living hinge 142 is a groove formed integrally formed at an attachment point between pawl section 134 and buckle section 130. As toothed section 126 of second member section 124 is inserted into tubular recess 132, hooked end 140 of pawl section 134 engaged with grooves 129. A void 144 is defined between an edge of side portion 136 and pawl section 134. Accordingly, to separate second member section 124 from first member section 122, a thin instrument, such as a needle, is inserted into void 144 in order to pry pawl section 134 upwardly.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

1. A cadaver mouth closure device, comprising:
a first member section terminating at a distal end in a first anchor for penetrating an upper or lower jaw of a cadaver, the first anchor defining at least a first pivotal retaining section having a base and at least a first groove section adjacent to the base, said first member section terminating at a proximal end in a first closure section; and
a second member section terminating at a distal end in a second anchor for penetrating the other jaw of the cadaver, said second member section having a second closure section for releasably engaging with the first closure section of said first member section to thereby secure closure of the cadaver mouth.

2. The closure device according to claim 1, wherein the first pivotal retaining section has a first conical surface mating with a reverse frusto-conical surface at the base.

3. The closure device according to claim 1, wherein the first anchor defines a second pivotal retaining section adjacent to the first pivotal retaining section.

4. The closure device according to claim 3, wherein the second pivotal retaining section has a base and the first anchor further defines a second groove section adjacent to the base of the second pivotal retaining section.

5. The closure device according to claim 1, wherein the first anchor is formed from a first metallic cap section that is attached to a molded anchor base section, and the first closure section is integrally molded with the molded anchor base section.

6. The closure device according to claim 5, wherein the molded anchor base section is inserted into a recess of the first metallic cap section.

7. The closure device according to claim 5, wherein the molded anchor base section is threaded into a threaded recess of the first metallic cap section.

8. The closure device according to claim 5, wherein the molded anchor base section further defines a retaining flange that prevents over insertion of the first anchor into the cadaver jaw.

9. The closure device according to claim 1, wherein the first closure section is a buckle section having a tubular recess and a pawl section, the second closure section is a toothed section that is configured and arranged to be received within the tubular recess, and the pawl section releasably engages a tooth of the toothed section.

10. The closure device according to claim 1, wherein the first groove section has a plurality of ribs and grooves disposed on at least a first side of the first member section to enhance flexibility of the first anchor with respect to the first closure section.

11. The closure device according to claim 10, wherein the second groove section has a plurality of ribs and grooves disposed on at least a first side of the second member section to enhance flexibility of the second anchor with respect to the second closure section.

12. A cadaver mouth closure device, comprising:
a first member section terminating at a distal end in a first anchor for penetrating an upper or lower jaw of a cadaver and terminating at a proximal end in a buckle section having a tubular recess and at least one pawl section; and
a second member section terminating at a distal end in a second anchor for penetrating the other jaw of the cadaver and having a toothed section defining a plurality of teeth, wherein upon insertion of the toothed section within the tubular recess, the one pawl section engages at least one of the plurality of teeth to thereby secure closure of the cadaver mouth.

13. The closure device according to claim 12, wherein the first anchor defines a first pivotal retaining section having a first conical surface mating with a reverse frusto-conical surface at the base.

14. The closure device according to claim 12, wherein the first anchor defines a second pivotal retaining section adjacent to the first pivotal retaining section.

15. The closure device according to claim 12, wherein the first anchor is formed from a first metallic cap section that is attached to a molded anchor base section, and the buckle section is integrally molded with the molded anchor base section.

16. The closure device according to claim 15, wherein the molded anchor base section is inserted into a recess of the first metallic cap section or threaded into a threaded recess of the first metallic cap section.

17. The closure device according to claim 15, wherein the molded anchor base section further defines a retaining flange that prevents over-insertion of the first anchor into the cadaver jaw.

18. The closure device according to claim 12, wherein the first member section has a first extension section connecting the first anchor with the buckle section, the first extension section having a plurality of ribs and grooves disposed on at least a first side of the first extension section to enhance flexibility of the first anchor with respect to the buckle section.

19. The closure device according to claim 12, wherein the toothed section further defines an elongated rib for mating with a corresponding structure defined within the tubular recess of the first member section.

20. A cadaver mouth closure device, comprising:
a first member section terminating at a distal end in a first anchor for penetrating an upper or lower jaw of a cadaver, the first anchor defining first and second pivotal retaining sections each having a base and at least a first groove section adjacent to the base, said first member section terminating at a proximal end in a buckle section; and
a second member section terminating at a distal end in a second anchor for penetrating the other jaw of the cadaver, said second member section having a toothed section defining a plurality of teeth, wherein upon insertion of the toothed section within the tubular recess, a the pawl section engages at least one of the plurality of teeth to thereby secure closure of the cadaver mouth.

21. A cadaver mouth closure device, comprising:
a first member section terminating at a distal end in a first anchor for penetrating an upper or lower jaw of a cadaver, the first member section meeting at least one of the following conditions (i), (ii), and (iii):
i) said first anchor defines at least a first pivotal retaining section having a base and at least a first groove section adjacent to the base, and said first member section terminates at a proximal end in a first closure section;
ii) said first member section terminates at a proximal end in a buckle section having a tubular recess and at least one pawl section; and
iii) said first anchor defines first and second pivotal retaining sections each having a base and at least a first groove section adjacent to the base, and said first member section terminates at a proximal end in a buckle section; and
a second member section terminating at a distal end in a second anchor for penetrating the other Jaw of the cadaver, the second member section meeting at least one of the following conditions (iv) and (v):
iv) said second member section has a second closure section for releasably engaging with the first closure section of said first member section to thereby secure closure of the cadaver mouth; and
(v) said second member section has a toothed section defining a plurality of teeth, wherein upon insertion of the toothed section within the tubular recess, a pawl section engages at least one of the plurality of teeth to thereby secure closure of the cadaver mouth.
